(19) United States
(12) Patent Application Publication
(10) Pub. No.: US 2019/0084473 A1
(43) Pub. Date: Mar. 21, 2019

(54) Optical Casing Having A Reduced Weight For A Motor Vehicle, Optical Module, And Vehicle Body Part

(71) Applicant: Compagnie Plastic Omnium, Lyon (FR)

(72) Inventors: Franck Leterrier, Saint Priest (FR); Issam Khayat, Lyon (FR); Martin Struss, Bratislava (SK)

(73) Assignee: Compagnie Plastic Omnium, Lyon (FR)

(21) Appl. No.: 16/063,541

(22) PCT Filed: Dec. 12, 2016
(86) PCT No.: PCT/FR2016/053324

§ 371 Date: Jun. 18, 2018

(30) Foreign Application Priority Data
Dec. 16, 2015 (FR) 1562522

(51) Int. Cl. B60Q 1/26; F21S 43/50

(52) U.S. Cl. CPC B60Q 1/2653; B60Q 1/2626; F21S 43/51

(57) ABSTRACT

The invention relates to an optical casing for a motor vehicle, including a top portion for receiving a glass panel, a bottom portion, and an assembly of lateral elements for connecting the top portion to the bottom portion, characterized in that the top portion forms a frame that is provided with a joint along the entire periphery thereof, said joint being designed to rest against a sealing surface of a housing in the vehicle.

### FIELD OF THE INVENTION

This invention relates to the technical field of optical devices for motor vehicles. In particular, the invention relates to an optical casing to reduce the weight of the optical device.

### BACKGROUND OF THE INVENTION

An optical casing is a casing adapted to receive a functional assembly, such as electrical, electronic and optical means, in order to fulfil the lighting function of a vehicle. Such an optical casing is closed by a transparent glass panel to form a sealed optical module.

Such an optical casing is assembled in a housing of a motor vehicle part (bumper, rear door, fender) provided for this purpose, by means of attachment points, and by fitting a seal between the back of the optical casing (opposite the glass panel) and the part (lining or skin in the case of a tailgate).

One disadvantage of this solution is that in order to access the functional assembly, for possible repairs, the optical casing must be removed completely from its housing.

Furthermore, with this solution, two groups of solid walls in parallel are required: the walls forming the casing of the optical module and the walls of the housing to which the optical module is attached. This leads to higher manufacturing costs (use of additional material) and makes the vehicle unnecessarily heavier.

To overcome this problem, an optical module is also known, whose casing is molded with the housing wall to which the optical module is attached (e.g. the lining of a tailgate).

However, with such a solution, the optical module which is in this case “integrated” cannot be removed, resulting in limited accessibility to the functional assembly.

### SUMMARY OF THE INVENTION

The main objective of this invention is to overcome the above-mentioned disadvantages by providing an optical casing whose walls can be perforated in order to reduce the weight of the casing as well as to reduce the weight of the housing for which it is intended.

The invention achieves this objective by transferring the sealing area to the top portion of the optical casing, i.e. just under the portion designed for receiving the glass panel.

The invention thus relates to an optical casing for a motor vehicle, comprising a top portion for receiving a glass panel, a bottom portion, and an assembly of lateral elements for connecting the top portion to the bottom portion. The top portion forms a frame that is provided with a seal along the entire periphery thereof, the seal being designed to rest against a sealing surface of a housing in the vehicle.

Such an optical module reduces the quantity of plastic material used to manufacture the elements required for the lighting function on board a motor vehicle. This reduction of material through “strap” connections between the bottom and top portions is allowed both on the optical module and on the housing into which it will be fitted (on a skin or tailgate lining for example, or on a bumper skin).

Moreover, this solution allows greater accessibility via the various openings.

The device may further comprise one or more of the following characteristics, taken alone or in combination:
the top portion comprises on its periphery a groove into which the seal is inserted;
the opening of the groove is oriented towards the outside of the optical casing;
the opening of the groove is oriented towards the bottom portion of the optical casing;
the bottom portion forms a perforated wall;
the bottom portion forms a frame;
the lateral elements form perforated walls.

The invention also relates to an optical module comprising an optical casing according to the invention, a glass panel closing said optical casing, and an assembly of functional elements mounted on the bottom portion and/or on the lateral connection elements.

The invention also relates to a motor vehicle bodywork part comprising a housing for optical module, and comprising an optical casing according to the invention, attached inside said housing, the seal resting against a sealing surface of the housing.

According to the invention, the housing may comprise a shoulder forming the sealing surface and against which the seal in the groove of the optical casing rests sealably. Preferably, the housing comprises perforated walls.

Finally, according to a particular embodiment, at least one of the perforated walls of the housing coincides with at least one of the perforated walls of the optical casing to provide access inside the optical casing.

### BRIEF DESCRIPTION OF THE DRAWINGS

The invention will be better understood on reading the accompanying figures, which are given solely by way of example and not limiting in any way, in which:

FIG. 1 illustrates a tailgate provided with a housing adapted to receive an optical casing according to the invention;

FIGS. 2A and 2B illustrate a particular embodiment of an optical casing according to the invention; FIG. 2B is a cross-section C-C of the housing of FIG. 2A;

FIG. 3A illustrates an optical module comprising an optical casing according to the invention;

FIG. 3B illustrates an embodiment of an optical casing provided with a glass panel;

FIG. 4 illustrates the positioning of an optical casing in its housing and the attachment elements;

FIG. 5A shows a cross-section A-A of the housing of FIG. 4;

FIG. 5B shows a cross-section B-B of the housing of FIG. 4;

FIG. 5C shows a cross-section B-B of a housing having a shoulder.

### DETAILED DESCRIPTION OF THE INVENTION

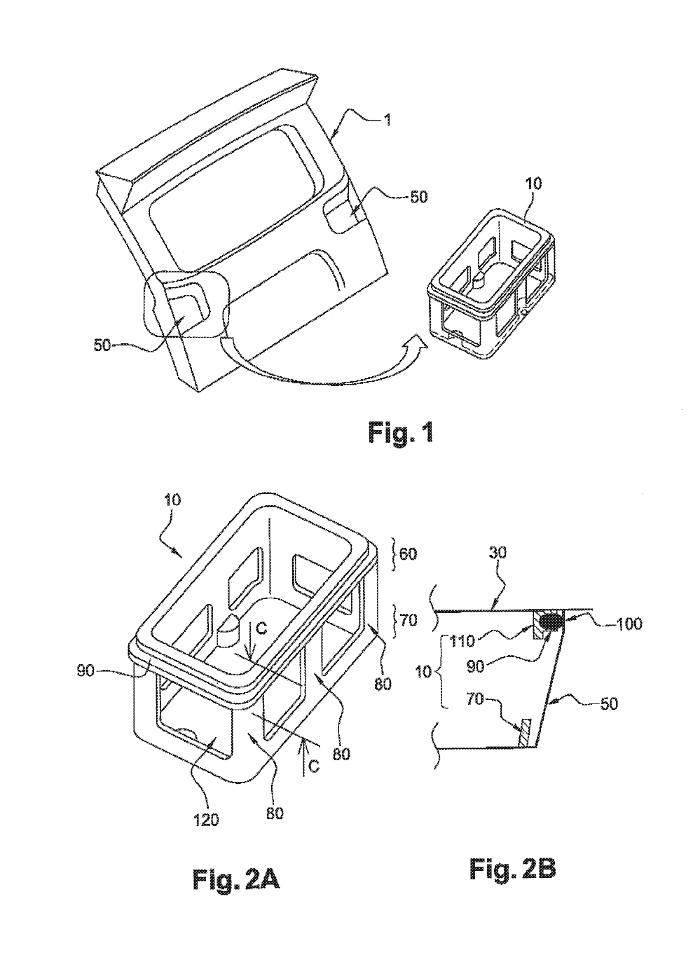

We now refer to FIG. 1 which illustrates an example of motor vehicle part 1, a tailgate, comprising a housing 50 adapted to receive an optical casing 10 according to the invention.

FIGS. 2A and 2B illustrate in more detail a particular embodiment of the optical casing 10 for a motor vehicle according to the invention.

FIG. 2A shows in three dimensions such an optical casing 10, while FIG. 2B is a cross-section C-C of a portion of this optical casing 10 with its glass panel 30 and its housing 50.

This optical casing 10 is adapted to receive a functional assembly 20 (electrical, electronic and optical means) and to be closed by a glass panel 30, so as to form an optical module 40.

Such an optical module 40 is designed to be attached in the housing 50 of the motor vehicle, provided for this purpose.

The optical casing 10 comprises a top portion 60 designed for receiving a glass panel: this portion is therefore designed to be positioned/oriented towards the outside of the vehicle. The optical casing 10 also comprises a bottom portion 70 designed to be positioned/oriented towards the inside of the vehicle, and an assembly of lateral elements 80 for connecting, preferably discontinuously (i.e. having at least one perforation), the top portion 60 to the bottom portion 70.

The top portion 60 forms a frame that is provided with a seal 90 extending along the entire periphery of the frame 60. This seal 90 is designed to rest against a sealing surface 100 of a housing 50 in the motor vehicle.

The seal 90 can be attached to the frame 60 in any way known by specialists.

According to an embodiment described on FIGS. 2A and 2B, the frame 60 is provided on its periphery with a groove 110 into which the seal 90 is inserted. Another structure for receiving the seal 90 could be used without leaving the scope of the invention, for example a rib onto which the seal having a slot provided for this purpose is pressed.

The opening of the groove 110 is oriented towards the bearing surface of the housing 50 against which the seal 90 is designed to rest so as to form a seal inside the housing 50, i.e. between the outside of the vehicle and the inside of the optical module 40.

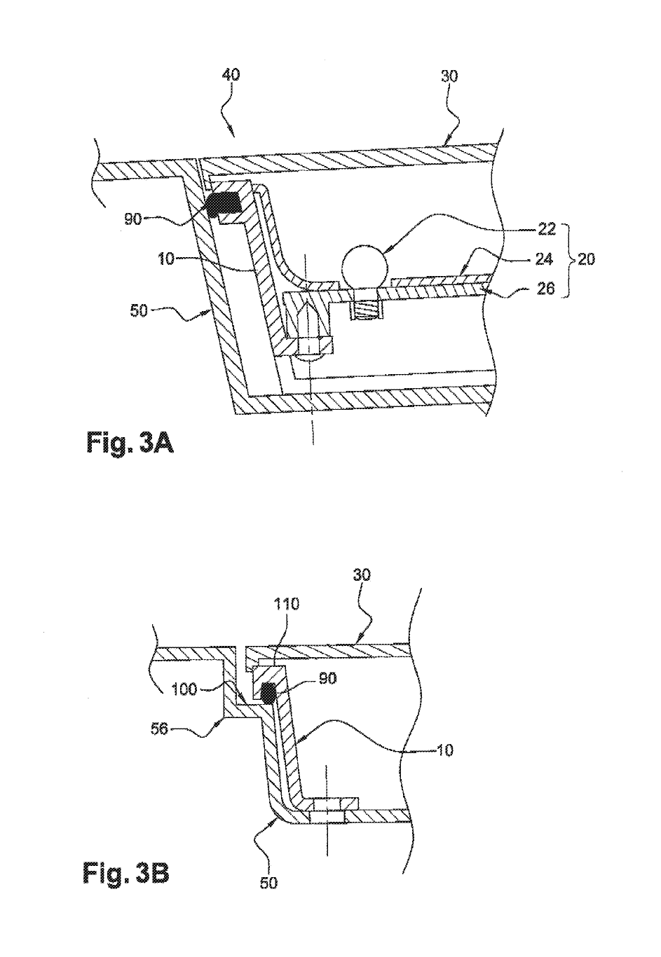

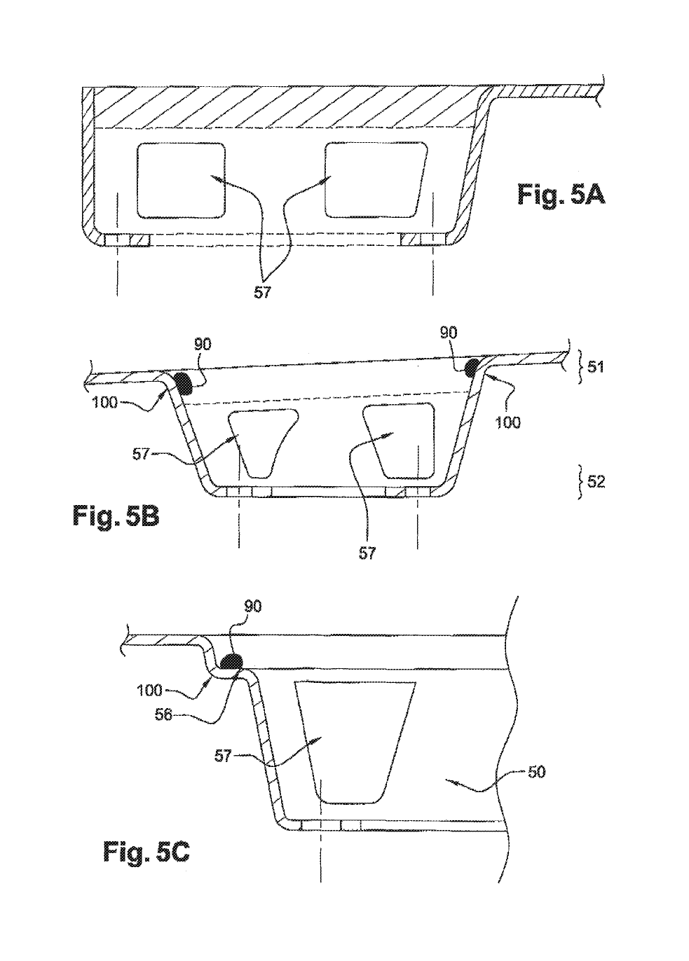

Thus, according to an embodiment (FIGS. 2A, 2B, 3A and 5B), the opening of the groove 110 is oriented towards the outside of the optical casing 10, and according to another example (FIGS. 3B and 5C), the opening of the groove 110 is oriented towards the bottom portion of the optical casing 10.

According to a preferred embodiment, the bottom portion 70 forms a perforated wall, comprising one or more openings 120. Since the inside of the optical casing 10 is sealed with the glass panel 30 and the seal 90, the quantity of material used to manufacture the optical casing 10 can be limited. Thus, the area of the bottom portion can be minimized. For example, the bottom portion 70 can be designed like a simple frame, as illustrated on FIGS. 2A and 2B.

Similarly, the lateral elements 80 advantageously form perforated walls (FIGS. 2A and 2B).

The only constraint on the assembly, consisting of the bottom portion 70 and the lateral elements 80, is to be able to attach a functional assembly (electrical, electronic and optical means) thereon, as illustrated on FIG. 3A.

Advantageously, the optical casing 10 is manufactured using a lightweight material adapted to support the various lighting functions (lighting, reflector, mask, etc.). For example, plastic materials and metal materials can be used alone or in combination. For example, the reflector can be made of polypropylene (PP) coated with a metallization layer, the glass panel 30 can be made of polymethylmetacrylate (PMMA), the casing can be made of polypropylene (PP) for example.

The material used for the optical casing 10 may advantageously be selected to help dissipate the heat generated by the electronic components inside the optical module 40. Aluminum parts are used to dissipate the heat generated by LED (Light Emitting Diode) lighting. Due to the openings in the casing 10 according to the invention, cooling parts of smaller size can be used, while nevertheless being capable of dissipating the heat given off by the lighting.

### Optical Module

The invention also relates to an optical module 40 (FIG. 3A) comprising an optical casing 10 according to the invention, a glass panel 30 closing the optical casing 10, and an assembly of functional elements 20 (bulb or LED 22, mirror 24, printed circuit board (PCB) 26) mounted on the lower portion 70 and/or on the lateral connection elements 80.

### Motor Vehicle Part

Such an optical module 40 is designed to be attached in a motor vehicle housing 50, provided for this purpose.

Thus, the invention also relates to a motor vehicle bodywork part 1 comprising a housing 50 for optical module 40, and comprising an optical casing 10 according to the invention, attached inside the housing 50, the seal 90 resting against a sealing surface of the housing 50.

The housing 50 comprises a top portion 51 (towards the outside of the vehicle) and a bottom portion 52 (towards the inside of the vehicle) designed for receiving the bottom portion 70 of the optical module, and an assembly of lateral elements 53 for connecting the top portion 51 to the bottom portion 52.

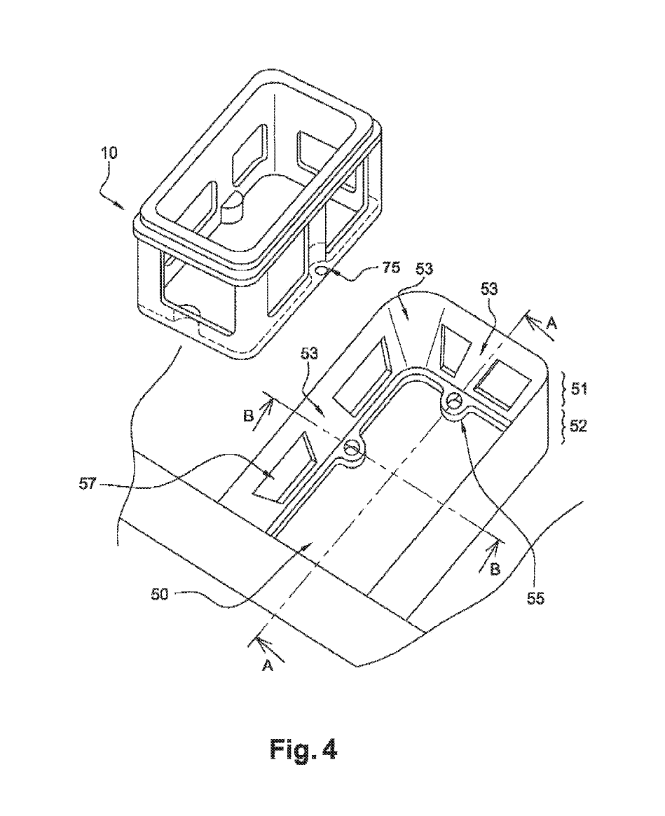

As illustrated on FIG. 4, the optical casing 10 is attached to housing 50 by attachment means. It can thus be screwed, clipped or attached by any other means in order to compress or stress the seal 90.

FIG. 4 illustrates an example according to which the bottom portion 70 of the optical casing 10 is a frame, having holes 75 distributed around the perimeter of the frame 70. The housing 50 comprises bearing and attachment areas 55 designed to maintain the optical casing 10 in position. As illustrated on FIG. 4, an element projecting towards the inside of the housing 50 could be used, each projecting element having a hole opposite the holes 75 when the optical casing 10 is inserted in position in the housing 50. The optical casing 10 now simply has to be attached to the housing 50, by means of screw, nut, rivet, etc.

According to an embodiment, illustrated on FIGS. 4 and 5A to 5C, the housing 50 comprises perforated walls. Since the inside of the optical casing 10 is sealed by the glass panel 30 and the seal 90, the quantity of material used to manufacture the housing 50 can be limited. Thus, the areas of the bottom portion 52 and the lateral walls 53 can be minimized. For example, the bottom portion 52 can be designed like a simple frame. The perforations in the housing 50 also improve the heat dissipation of the optical module.

FIG. 5A shows a cross-section A-A of the housing of FIG. 4. FIG. 5B shows a cross-section B-B of the housing of FIG. 4.

FIG. 5C shows an alternative embodiment to that shown on FIG. 5B, According to this embodiment, the top portion 51 of the housing 50 comprises a shoulder 56, forming the sealing surface, and against which the seal 90 in the groove 110 of the optical casing 10 rests sealably. The advantage of a such an embodiment is that the force required to position the optical casing 10 in the housing 50 maintains the seal 90 in the groove 110 and improves the compression of the seal necessary for it to perform its sealing function.

Consequently, tightening the attachment means, such as screws, in the holes in order to attach the casing 10 in the housing 50, crushes the seal 90 on the shoulder. The sealing can therefore be precisely adjusted.

Thus, according to an embodiment example (FIG. 5B), the opening of the groove 110 is oriented towards the outside of the optical casing 10, and according to another example (FIG. 5C), the opening of the groove 110 is oriented towards the bottom portion of the optical casing 10.

The openings, made possible due to the sealing system in the top portion of the casing 10, at the bottom portion 70, the lateral elements 80 and the walls of the housing 50, reduce the quantity of material used to manufacture the optical casing 10 and the housing 50, and therefore reduce the weight of the vehicle. These openings also allow easy maintenance, since the elements of the functional assembly 20 can advantageously be accessed through the openings.

For maintenance purposes, the openings 120 of the optical casing 10 are preferably located opposite the openings 57 of the housing. The defective element of the functional assembly 20 can therefore be removed, without removing the optical casing 10, and therefore, without having to touch the sealing area. For example, at least one of the perforated walls of the housing 50 coincides with at least one of the perforated walls of the optical casing 10 to provide access to the bulb 22 in order to replace it.

As illustrated on FIG. 1, the part may be a motor vehicle tailgate.

Finally, the various elements, optical casing 10, optical module 40 and motor vehicle part 1, are preferably made of plastic material. The use of this material allows various perforations and complex forms to be made, in a single manufacturing step.

The invention is not limited to the embodiments described and other embodiments will be clearly apparent to those skilled in the art. The motor vehicle part may in particular be a bumper or any other outer bodywork part comprising a dedicated housing.

1. Optical casing for a motor vehicle, comprising a top portion for receiving a glass panel, a bottom portion, and an assembly of lateral elements for connecting the top portion to the bottom portion wherein;
the bottom portion forms a frame;
the top portion forms a frame that is provided with a seal along the entire periphery thereof, said seal being designed to rest against a sealing surface of a housing in the vehicle; and
the lateral elements form perforated walls.

2. Optical casing according to claim 1, wherein the top portion comprises on its periphery a groove into which the seal is inserted.

3. Optical casing according to claim 2, wherein the opening of the groove is oriented towards the outside of the optical casing.

4. Optical casing according to claim 2, wherein the opening of the groove is oriented towards the bottom portion of the optical casing.

5. Optical casing according to claim 1, wherein the bottom portion forms a perforated wall.

6. (canceled)

7. (canceled)

8. Optical module comprising an optical casing according to claim 1, further comprising a glass panel closing said optical casing, and an assembly of functional elements mounted on the bottom portion and/or on the lateral connection elements.

9. Motor vehicle bodywork part comprising a housing for an optical module;
wherein the motor vehicle bodywork part comprises the optical casing according to claim 1, attached inside said housing, the seal resting against a sealing surface of the housing, and the housing comprises perforated walls, at least one of the perforated walls of the housing coinciding with a least one of the perforated walls of the optical casing to provide access inside the optical casing.

10. Bodywork part according to claim 9, wherein the housing comprises a shoulder, forming the sealing surface, and against which the seal in of the groove of the optical casing rests sealably.

11. (canceled)

12. (canceled)
